(19) United States
(12) Patent Application Publication
(10) Pub. No.: US 2010/0165108 A1
(43) Pub. Date: Jul. 1, 2010

(54) Image Capture Device used for Monitoring and Monitor Method Thereof

(76) Inventor: Hsiu-Hung Pien, Hsinchu City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/505,564

(22) Filed: Jul. 20, 2009

(30) Foreign Application Priority Data
Dec. 30, 2008 (TW) 097151470

(51) Int. Cl. H04N 7/18

(52) U.S. Cl. 348/155; 348/E07.085

(57) ABSTRACT

An image capturing device used for monitoring and a monitoring method thereof are disclosed. The image capturing device is used to monitor movements from a specific area. The monitoring method comprises the following steps: controlling an image capturing module of the image capturing device in order to record images continuously from a specific area; detecting a changing portion within the image; focusing and magnifying the changing portion detected within the image and executing a monitoring recording process to perform a consecutive shooting.

### BACKGROUND OF THE INVENTION

1. Field of the Invention

The present invention relates to an image capturing device used for monitoring and a monitoring method thereof, particularly to an image capturing device and a monitoring method thereof which is able to detect the movements of the images.

2. Description of the Related Art

Monitoring systems are employed commonly in various places, such as in traffic intersections, buildings or in ordinary family homes. Current monitoring systems are implemented at a fixed location to record or monitor a particular venue. Images can then be retrieved from a specific place at a specific time for investigational purposes. However, the implementation costs of monitoring systems of the current design are very expensive, and the systems are required to be installed at a fixed location and cannot be freely relocated. Therefore, such systems are only suitable to be used in community areas, buildings or public venues, and are not suitable to be implemented by ordinary users or families. Furthermore, the monitoring systems of the current design usually decrease the resolution of the recorded images in order to minimize the usage of storage space; this low resolution may result in unclear images, thus obstructing the recognition process when undertaking an investigational process. Moreover, the monitoring systems of the current design cannot perform immediate image adjustments during the recording process.

Therefore, a new image capturing device used for monitoring and a monitoring method thereof are needed to resolve the problems of the prior art.

### SUMMARY OF THE INVENTION

The object of the present invention is to provide an image capturing device used for monitoring and a monitoring method thereof, which is able to resolve the difficulty of monitoring device adjustment as well as the problem of low image quality.

In order to achieve the abovementioned objectives, the present invention presents an image capturing device used for monitoring movements of a specific area. The image capturing device comprises a central processing unit, an image capturing module, a motion detection module and a focusing module. The image capturing module is used to capture images from a specific area; the motion detection module is electrically connected with the image capturing module to detect any movements within the image of the specific area; the focusing module is used for focusing and magnifying the changing portion of the image after a change in the specific area is detected by the motion detection module; the central processing unit is electrically connected to the image capturing module, the motion detection module and the focusing module. The central processing unit drives the image capturing module capturing the changing portion magnified by the focusing module to a still image.

The monitoring method for the image capturing device of the present invention comprises the following steps: making the image capturing module of the image capturing device to record images continuously from a specific area; detecting for a changing portion within the image; focusing and magnifying the changing portion of the image; and executing a monitoring shooting process to perform a consecutive shooting to the changing portion.

### BRIEF DESCRIPTION OF THE DRAWINGS

FIG. 1 shows the structural diagram of an image capturing device of the present invention.

FIG. 2 is a flow chart of the shooting process for monitoring of the image capturing device of the present invention.

### DETAILED DESCRIPTION OF THE PREFERRED EMBODIMENT

The advantages and innovative features of the invention will become more apparent from the following preferred embodiments.

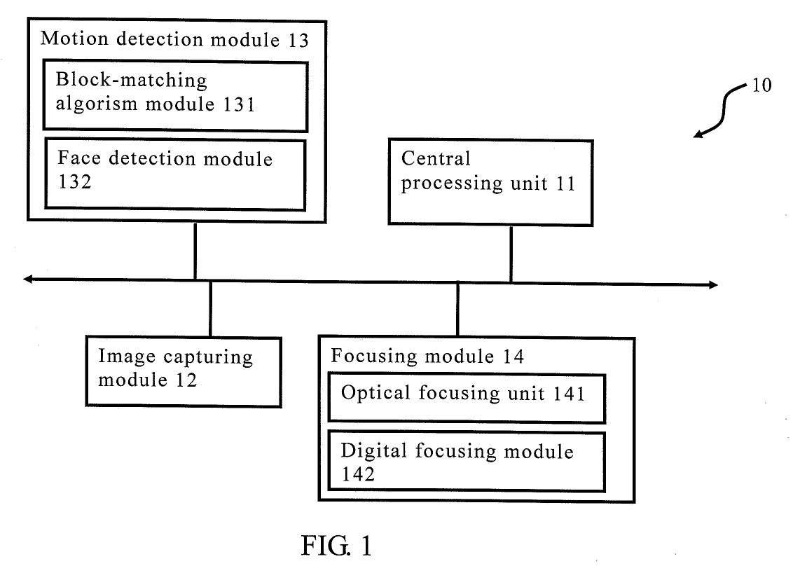

Please refer to FIG. 1 for the structural diagram of an image capturing device of the present invention.

An image capturing device 10 of the present invention is used for monitoring purposes. It can be used to monitor movements at a specific area and execute continuous recording by a monitor recording process, or take consecutive shooting by a monitor shooting process. The process of executing continuous recording and the process of taking consecutive shooting will be explained in further detail. The image capturing device 10 comprises a central processing unit 11, an image capturing module 12, a motion detection module 13 and a focusing module 14, wherein these modules are electrically connected to each other. The central processing unit 11 is used to control the operations of the abovementioned modules. The image capturing module 12 is used to capture an image from a specific area, and the motion detection module 13 is then used to detect for any movement within the image of the specific area. The motion detection module 13 comprises a block-matching algorism module 131 and a face detection module 132. The block-matching algorism module 131 is used to compare and detect any partial changes between the blocks of the images by the block-matching algorism. The matching method of the motion detection module 13 is not limited to the said block-matching algorism. The face detection module 132 is used to identify whether a face is present in an image. There will be no further discussion on the block-matching algorism and the face detection method as these methods are not the focus of the present invention and are well-known in the art.

The focusing module 14 is used to adjust the focus of the image capturing device 10, and to provide the ability of auto-focus and image magnification. The focusing module 14 comprises an optical focusing unit 141 and a digital focusing module 142. The optical focusing unit 141 is located inside the image capturing module 12 and used to adjust the focus through optical lenses. The digital focusing module 142 is electrically connected with image capturing module 12, and it adjusts the focus of image capturing device 10 through digital focus. However, the present invention is not only limited to abovementioned focusing methods. The image capturing device 10 can focus and track the changing portion of the image by means of the focusing module 14. If a face is identified in an image, the focusing module 14 is used to track the face by changing the focus of the image capturing device 10. As a result, the central processing unit 11 can drive the image capturing module 12 to capture the changing portion magnified by the focusing module 14 to a still image.

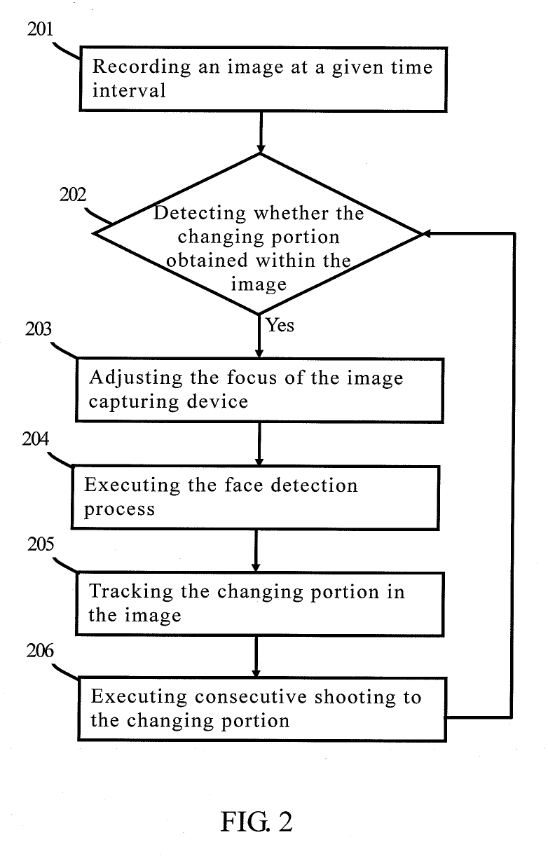

Next, please refer to FIG.2 for the monitoring method of the present invention. Take note that although the monitoring method is demonstrated through the image capturing device 10, the monitoring method of the present invention is not only restricted to being performed with the image capturing device 10.

Please refer to FIG.2 for the flow chart of the shooting process for monitoring of the image capturing device of the present invention.

First proceed with step 201: recording an image at a given time interval.

The central processing unit 11 controls the image capturing module 12 to record images at a given time interval. The time interval can be set at zero, one minute, or 10 minutes. However, the present invention is not limited to the above mentioned time lengths, so images can be obtained at various intervals of time.

Next proceed to step 202: detecting whether the changing portion obtained within the image.

The central processing unit 11 determines whether there is any changing portion in the images obtained at different times by means of the block-matching algorism module 131. Take note that the detecting method of the present invention is not limited to the block-matching computational method.

If there is a changing portion in the image, proceed with step 203: adjusting the focus of the image capturing device.

The focusing module 14 can adjust the focus of the image capturing device 10 by performing the focusing process of the optical focusing unit 141 as well as the digital focusing module 142. Therefore, the changing portion captured by the image capturing module 12 can be focused and magnified.

Next, proceed with step 204: executing the face detection process.

The central processing unit 11 is able to identify whether a face in present in the image by means of the face detection module 132. If a face is present, the focusing module 14 is used to track the face by adjusting the focus in order to obtain a clearer facial image.

Next, proceed with step 205: tracking the changing portion in the image.

When the image is continuously changing, the central processing unit 11 tracks for these differences continuously by means of the focusing module 14, such that the changing portion or the human face region can be maintained at optimal clarity.

For example, when a walking person is present in the image, the face detecting module 132 will detect the face of the person. The central processing unit 11 then adjusts the focus towards the face by means of the focusing module 14. The focusing module 14 is employed to adjust the focus continuously in correspondence with the person's movement. Therefore, when a person is present in the monitoring range of the image capturing device 10, the focusing module 14 is able to track the movement of the person.

Take note that during the monitoring process, the image capturing device 10 does not need to execute step 203 to 205 in a sequential manner, or perform all the said steps from 203 to 205. The user can adjust the monitoring process according to the function of the image capturing device 10.

Simultaneously proceeds with step 206: executing consecutive shooting to the changing portion.

During the execution of step 203 to step 205, the central processing unit 11 drives the image capturing module 12 to perform consecutive shooting to the changing portion in order to obtain still images. The time interval between capturing each image can be defined by the user. For example, it can be one or two seconds, but the present invention is not restricted to these time intervals.

Next, return to step 202, and determine whether there is any changing portion between the consecutive images taken in step 206. If there is no changing portion between the images, the focusing module 14 then controls the focus of the image capturing device 10 by adjusting it back to its initial state by recording at a wide angle.

Take note that the monitoring process of the present invention is not restricted to the abovementioned sequence. The sequence can be different as long as it is able to achieve the objectives of the present invention.

The image capturing device 10 is used prevalently by the public, and it has a powerful capability to process the captured images. Therefore, the abovementioned image capturing device and method thereof for monitoring is able to resolve the difficulty of monitoring device adjustment and the problem of low image quality.

Although the present invention has been explained in relation to its preferred embodiment, it is also of vital importance to acknowledge that many other possible modifications and variations can be made without departing from the spirit and scope of the invention as hereinafter claimed.

What is claimed is:

1. An image capturing device, using for monitoring movements of a specific area, comprising:
an image capturing module for capturing images from the specific area;
a motion detection module electrically connected with the image capturing module for detecting any movement within the image of the specific area;
a focusing module for focusing and magnifying a changing portion of the image after a change in the specific area is detected by the motion detection module; and
a central processing unit electrically connected to the image capturing module, the motion detection module and the focusing module, wherein the central processing unit drives the image capturing module capturing the changing portion magnified by the focusing module to a still image.

2. The image capturing device as claimed in claim 1, wherein the motion detection module comprises a block-matching algorism module.

3. The image capturing device as claimed in claim 1, wherein the motion detection module comprises a face detection module.

4. The image capturing device as claimed in claim 1, wherein the focusing module comprises an optical focusing unit and a digital focusing module, wherein the optical focusing unit is located inside the image capturing module, and wherein the digital focusing module is electrically connected with the image capturing module.

5. The image capturing device as claimed in claim 1, wherein the image capturing module proceeds with continuous recording when the still image is not captured.

6. The image capturing device as claimed in claim 1, wherein a plurality of the still images are captured by the image capturing module through consecutive shooting.

7. A monitoring method for an image capturing device, wherein the image capturing device comprises an image capturing module to monitor movements for a specific area, the method comprises the following steps:
making the image capturing module of the image capturing device to record images continuously from the specific area;
detecting for a changing portion within the image;
focusing and magnifying the changing portion detected within the image; and
executing a monitoring shooting process to perform a consecutive shooting to the changing portion.

8. The monitoring method for an image capturing device as claimed in claim 7 further comprises a step of recording the images consecutively at a given time interval.

9. The monitoring method for an image capturing device as claimed in claim 7 further comprises a face detection process, wherein the execution of the face detection process comprises the following steps:
identifying a face from the image;
tracking for the face; and
executing consecutive shooting.

10. The monitoring method for an image capturing device as claimed in claim 7, further comprises a step of executing a block-matching computational to detect for any changing portion within the image.
